(19) United States
(12) Patent Application Publication
(10) Pub. No.: US 2008/0018210 A1
(43) Pub. Date: Jan. 24, 2008

(54) Security Locker For Beverages

(76) Inventor: James Hayes, Middlesex (GB)

Correspondence Address: CONNOLLY BOVE LODGE & HUTZ, LLP, P O BOX 2207, WILMINGTON, DE, 19899, US

(21) Appl. No.: 11/578,319

(22) PCT Filed: Apr. 5, 2005
(86) PCT No.: PCT/GB05/01288

§ 371 Date: Jul. 5, 2007

(30) Foreign Application Priority Data
Apr. 13, 2004 (GB) 0408107.1

(51) Int. Cl. G07F 7/02

(52) U.S. Cl. 312/215; 312/326

(57) ABSTRACT

A security locker 10 holds an open drink 14 so that it cannot readily be tampered with, and is such that an inebriated person can (1) readily open the locker door 12 by a single action, e.g. by the insertion of a credit card 16 or other flat or card-like key 16, (2) can readily insert and/or remove the drink 14 due to the locker shape, e.g. to guide a hand reaching into the locker 10 to facilitate retrieving the drink 14 and make spillage less likely, and (3) is less likely to be wounded stumbling against the locker 10, e.g., since said door 12 is adapted not to open outwards but to move around the inside of the locker periphery, rotating about a pivot 38, and the locker 10 has a suitable external shape, convex facing the front. After inserting said drink 14, closing and relocking the door 12, the key 16 is retained and a token 20 issued, required to be re-inserted to remove said drink 14. The locker 10 has readily removable internal floor means 26, a spill tray 40 in two parts, separately removable from the locker 10, a window 44, internal lighting 46, means 48, 50 to provide two different indications to indicate whether the locker 10 is already in use or not, means 52 to inhibit storing drugs and/or small weights in the locker, e.g. a pressure-sensitive pad 52 at the floor of the locker 10 to prevent door closure if the contents have less than a predetermined minimum weight, means to detect presence of liquid, e.g. alcohol, and prevent door closure in the absence thereof, has limited vertical and horizontal dimensions, means 56 enabling a plurality of such lockers 10 to be fastened together in a bank 76, secured, e.g. below, a support 60, e.g. table 64 or ledge 70, and readily removable from the bank 76 without releasing other lockers 10 of the bank 76 from the support 60, and is adapted to take payment. The locker 10 or bank 76 is located within a building 68, within 2 m of a toilet entrance 78, within 5 m of a dance floor 80, e.g. provided to a parapet 72 in the region of a perimeter portion of the dance floor 80. A said token 20, e.g. flat or card-like, is provided with means 22 for attaching it to the body or clothing of a person so that it cannot readily be removed without the knowledge of the person, e.g. a strap 22 suitable to go round the wrist or forearm.

### THE FIELD OF THE INVENTION

This invention relates to safety means.

### BACKGROUND

There is a current problem of drinks being spiked or tampered with in a social environment.

### THE INVENTION

The inventor believes that it should be possible to deal with this problem to a large extent by providing a place where one can put one's drink knowing it will remain safe, i.e. untouched, e.g. when going for a dance in a nightclub, or going to the toilet there or in a public house (pub) or in a restaurant or in a leisure centre, or in any other social environment.

The safe place should be easy to clean and, as will appear from the following, easy to change.

According to one aspect of the invention, there is provided a security locker, which is adapted to hold with security an open drink, and having at least one of the following characteristics: such that the locker can be readily opened by an inebriated person; such that the drink can be readily inserted and/or removed by an inebriated person; such as to avoid or reduce the likelihood that an inebriated person coming close to the locker, e.g. stumbling against the locker, will be wounded.

According to another aspect of invention, there is provided a security locker with a lockable door and adapted to hold an open drink with security so that it cannot readily be tampered with. The word “door” refers to any suitable type of closure. The open drink may, for example, be a drink in a glass, or an opened bottle of drink.

Preferably, said door is adapted to be unlocked and opened readily by an inebriated person. Preferably, said door is adapted to be unlocked and opened by a single action. Preferably, the locker is adapted for said door to be unlocked and opened by the insertion of a credit card or other flat or card-like key. This will usually be individual to the locker, e.g. by having a magnetic stripe correspondingly coded. The door may be closed by hand, preferably by means of a recessed handle.

Preferably, the locker is adapted: for said door to be unlocked and opened by the insertion of a key (e.g. for insertion of said drink) and then, after closing and re-locking of the door, for retention of the key and issue of a token to be re-inserted to unlock and re-open the door (e.g. for removal of said drink). The locker may then retain the token and the door may then be closed and locked to return the key.

The token is preferably designed to have an attachment means for attaching it to the body or clothing of a person so that it cannot readily be removed without the knowledge of the person, and preferably has similar functions and shape to said key, e.g. being flat or card-like and adapted for insertion to unlock said door. This may be a sturdy tough strap suitable to go round the wrist, e.g. made of nylon.

Embodiments can be provided with various safety devices: e.g. two openings in succession to be refused, if using same locker and same key.

Preferably, the locker is shaped so that its contents (e.g. said drink) can be readily inserted and/or removed by an inebriated person.

Preferably, the locker comprises (internal) means to support an open drink so as to enable it to be retrieved easily and (at the same time) reduce the likelihood that it will be spilled in so doing.

The locker may comprise (internal) means to locate an open drink and guide a person's hand reaching into the locker to retrieve the drink so as to facilitate this retrieval.

Preferably, the locker is such as to avoid or reduce the likelihood that an inebriated person coming close to the locker, e.g. stumbling against the locker, will be wounded. Preferably, said door is adapted not to open outwards. Preferably, said door is adapted to move around the periphery of the locker. Preferably, said door is adapted to move around the inside of the locker. Again, said door may be adapted to move around the periphery of a storage area inside the locker. Preferably, said door is adapted to rotate around a pivot.

The locker may have an external shape designed to reduce the likely wounding of an inebriated person stumbling against the locker. It may have a shape convex facing the front. Preferably, it is of substantially semi-circular shape facing the front.

Preferably, the locker has readily removable internal floor means. E.g. such means can readily be removed to facilitate cleaning after spillage of the drink. The locker may comprise a spill tray to catch spilled drink. Preferably, the spill tray is in two parts, separately removable from the locker. It may have finger holes or ledges to facilitate this removal.

Preferably, said door comprises a window portion to facilitate viewing of the contents. This is preferably made of high-impact-resistant plastics material, e.g. polycarbonate. The whole door may be of suitable clear (or slightly translucent) plastics material.

Preferably, the locker comprises means to facilitate internal lighting of the locker.

Preferably, the locker comprises indication means adapted to provide two different indications to indicate whether the locker is already in use or not, e.g. red and green lights on the locker.

Preferably, the locker comprises means to inhibit the storing of drugs and/or small weights, e.g. maximum 20 g or maximum 10 g, in the locker, e.g. of drugs by drug dealers.

More preferably, the locker comprises means to detect presence of liquid, e.g. alcohol, and prevent door closure in the absence thereof, e.g. when another sensor senses that there is something in the locker. Again, the locker may comprise means to sense the presence of drugs, and possible then provide an alarm.

Again, the locker may comprise a pressure-sensitive pad at the floor of the locker to prevent door closure if the contents have less than a predetermined minimum weight. This may be selected with a view to permit closure with a container of, drink but not with a relatively small packet, as of drugs.

Possibly, the locker has intelligent software, e.g. for lock coding, e.g. interlock features, with a view to making it difficult for one person to deposit a package inside the locker and another person to retrieve the package from the locker, (e.g. by tending to make it impossible for a package to be left in the locker when a drink is taken out, or by the exchange of a key for the token mentioned above, or by making sure that one person cannot use the locker with the same key twice in succession, unless some other party uses the locker in between,) or to ensure that a person does not use two of the lockers (electronically interlinked) simultaneously.

To reduce the likelihood of vandalism, e.g. trying to pull the locker away from its support, the locker is preferably given a shape that is not re-entrant, i.e. it does not become narrower towards the back so as to give a would-be vandal purchase to pull it forwards away from a support.

Preferably, the locker has an internal storage space for said drink less than substantially 40 cm high, more preferably less than substantially 30 cm high, both of which may accommodate a bottle, even more preferably less than substantially 20 cm high, which may accommodate only a glass and not a bottle.

Preferably, the locker has an internal storage space of less than 20 cm maximum horizontal dimension, which can accommodate a bottle and glass side by side, or less than 10 cm maximum horizontal dimension, so that it can only accommodate one of these.

Preferably, the locker has means enabling a plurality of such lockers to be fastened together, e.g. securing means enabling it to be readily removably secured to a support. Preferably, the locker is adapted to be secured underneath the support. Preferably, the securing means are adapted to allow the locker to be removed readily from a bank of such lockers secured to said support without releasing other lockers of the bank from the support.

The locker maybe adapted to take payment, e.g. by charging to a credit card, e.g. used as a key, or by being coin-operated.

According to another aspect of the invention, there is provided a bank of lockers comprising any such locker. The bank may comprise securing means enabling the lockers to be readily removably secured to a support. The bank may further be adapted to allow one locker to be removed readily from the bank without releasing the other lockers from the support.

Another aspect of the invention provides a combination of any such locker or bank, with a support for the same, i.e. adapted to hold the same securely. Preferably, the locker or bank is secured underneath the support.

The support may comprise a table, e.g. provided with securing means suitable to secure the table to a building. The support may comprise a ledge extending from a parapet.

Another aspect of the invention provides a building comprising at least one such locker, bank or combination. The building may comprise a toilet with a said locker within 2 m of an entrance to the toilet. The building may comprise a defined dance floor with a said locker within 5 m of the dance floor. There may be, and often is, a parapet in the region of a perimeter portion of such a dance floor, preferably, said parapet is provided with a said locker.

Another aspect of the invention provides a token adapted for insertion in any such locker, or in a said locker of any such bank, combination or building, to unlock the same. The word ‘insertion’ may include ‘partial insertion’ as the case may be. Each locker may be identified by an individual number. Preferably, if a drink is then left in the locker, this will not close and return the key, e.g. due to the presence of the drink being sensed by a pressure-sensor.

The token is preferably designed to have an attachment means for attaching it to the body or clothing of a person so that it cannot readily be removed without the knowledge of the person, and preferably has similar functions and shape to said key, e.g. being flat or card-like and adapted for insertion to unlock said door. This may be a sturdy tough strap suitable to go round the wrist or forearm and not be readily removed without the knowledge of the wearer. Such a strap may be permanently closed so that it can only be taken off over the hand. It may need to be slightly forced over the hand to remove ft from the arm. It is preferably sturdy and difficult to cut readily, e.g. being made of nylon, e.g. of minimum thickness 2 mm and/or minimum width 1 cm.

Another aspect of the invention provides a combination of such a token and said locker.

### DESCRIPTION RELATING TO THE DRAWINGS

Reference will now be made by way of example to the accompanying drawings, in which:

FIG. 1 is a front perspective view of a locker embodying the invention;

FIG. 2 is a horizontal cross-section of the same;

FIG. 3 is a horizontal cross-section of a variation of the same;

FIG. 4 is a plan view of a token embodying the invention;

FIG. 5 is a view corresponding to FIG. 1, looking in through the partially opened doorway;

FIG. 6 is a partially cut-away front view of the FIG. 1 embodiment;

FIG. 7 is a partial front view corresponding to FIG. 6 of a variation of the FIG. 6 embodiment;

FIG. 8 is a perspective view of a table embodying the invention;

FIG. 9 is a schematic plan view of parts of a building embodying the invention;

FIG. 10 is a schematic vertical cross-section on the line 10-10 of FIG. 9;

FIG. 11 is a rear perspective view of the FIG. 1 embodiment;

FIG. 12 is a rear view of a support for a bank of lockers embodying the invention; and

FIG. 13 is a front view of the FIG. 12 embodiment.

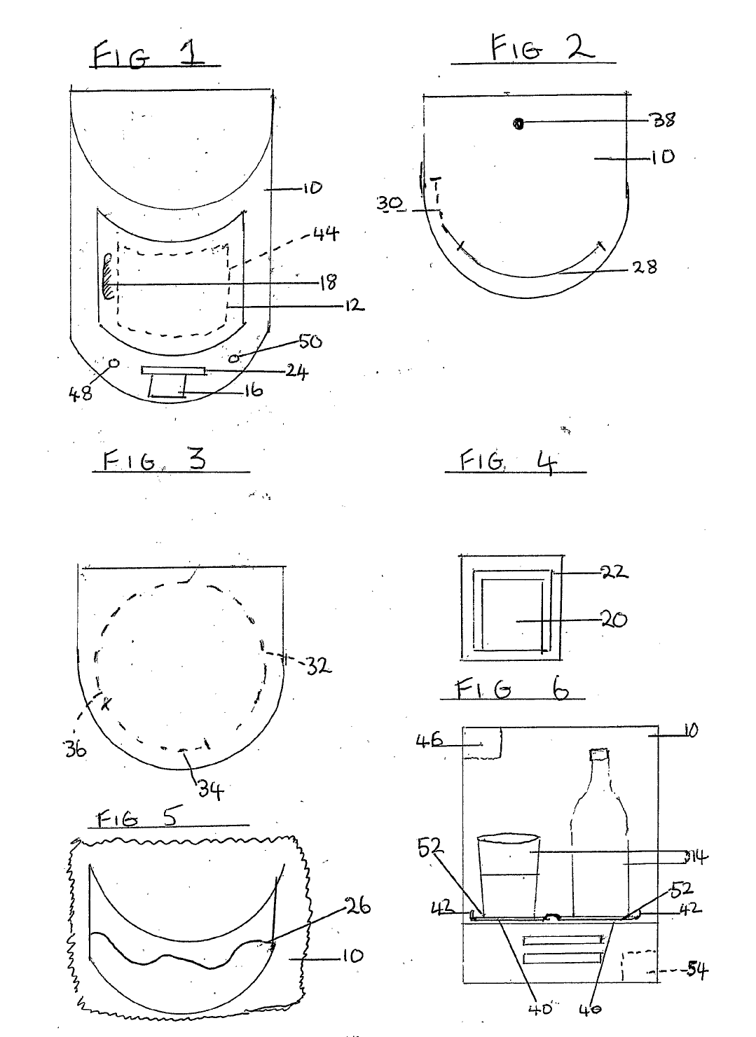

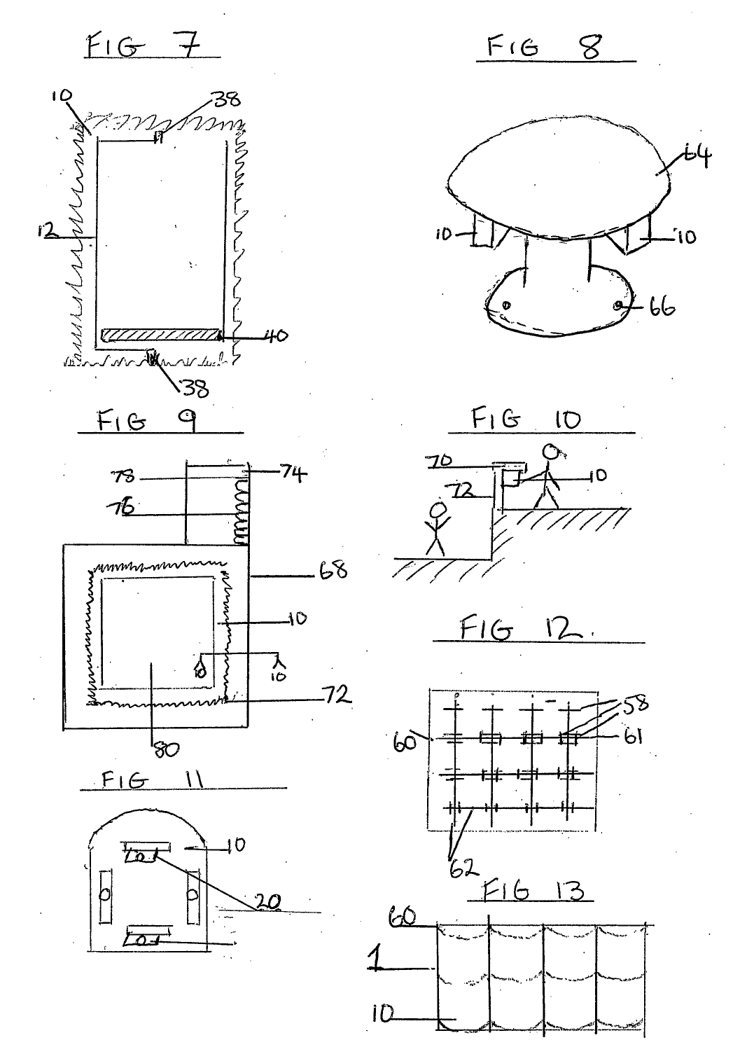

Referring to the drawings, a security locker 10 has a lockable door 12 300 mm wide and 400 mm high and is adapted to hold an open drink 14 with security so that ft cannot readily be tampered with. The open drink 14 is a drink 14 in a glass, or an opened bottle of drink 14.

Said door 12 is adapted to be unlocked and opened by a single action, namely by the insertion of a credit card 16 or other flat or card-like key 16, for insertion of said drink. The door can be closed by hand, by means of a recessed handle 18. The door will then automatically re-lock, and the locker will retain the key 16 and issue a token 20 instead. This is to be re-inserted to unlock and re-open the door for removal of said drink. The locker then retains the token and the door can then be closed and locked to return the key.

The token 20 has attachment means 22 for attaching ft to the body or clothing of a person so that it cannot readily be removed without the knowledge of the person. The attachment means 22 are a sturdy tough strap suitable to go round the wrist, e.g. made of nylon which spring flat to token 20 for re-insertion in slot 24. The token has similar functions and shape to said key, e.g. being flat or card-like and adapted for insertion to unlock said door.

The locker comprises internal means in the form of a guide 26 to support the open drink so as to enable it to be retrieved easily and at the same time reduce the likelihood that it will be spilled in so doing.

The locker comprises (internal) means, the same means 26, to locate the open drink when placing it in the locker and guide a person's hand reaching into the locker to retrieve the drink so as to facilitate this retrieval.

Said door 12 is adapted not to open outwards. It is adapted to move around the periphery of the locker, from position 28 to position 30, inside the locker, or around the periphery of a storage area 32 inside the locker, from position 34 to position 36. The door is adapted to rotate around a pivot 38, top and bottom of the locker, with a false floor 40 to facilitate this.

The locker 10, FIG. 2, has a shape convex facing the front, in fact substantially semi-circular shape facing the front.

The false floor 40 is internal and readily removable, and can readily be removed to facilitate cleaning after spillage of the drink. The floor comprises a spill 40 tray to catch spilled drink, in two parts, separately removable from the locker, with finger holes or ledges 42 to facilitate this removal.

Said door 12 comprises a window portion 44 to facilitate viewing of the contents, and there are lamp means 46 to facilitate internal lighting of the locker.

The locker comprises indication means 48, 50 adapted to provide two different indications to indicate whether the locker is already in use or not, namely red and green lights 48, 50 respectively.

The locker comprises means to inhibit the storing of drugs and/or small weights, comprising a pressure-sensitive pad 52 at the floor of the locker to prevent door closure f the contents have less than a predetermined minimum weight.

The locker has intelligent software 54, e.g. for lock coding, e.g. interlock features with other such lockers for the purposes mentioned above.

The locker has a shape that is not re-entrant, i.e. it does not become narrower towards the back.

The locker has an internal storage space 32 for said drink less than substantially 40 cm high and of less than 20 cm maximum horizontal dimension.

The locker 10 has securing means 56 (horizontal and vertical ears 56 perpendicular to the back of locker 10) enabling a plurality of such lockers to be fastened together, and/or to be readily removably secured to a support 60, and one such locker 11 to be removed readily from a bank 76 of such lockers secured to said support without releasing other lockers of the bank from the support. This securing means 56 is in the form of vertical and horizontal pierced ears 56, aligning with slots 58 in the support 60 to receive horizontal and vertical retaining rods 62 respectively, each common to a row or column of the lockers, so that removal of one horizontal rod 62 and one vertical rod 62 will release only one locker, 11 as shown. Otherwise, each rod 62 is itself locked in position by a padlock or other lock 61.

The support 64, FIG. 8, comprises a table 64, provided with securing means 66 suitable to secure the table to (e.g. the floor of) a building 68; or support 70, FIGS. 9 and 10, comprises a ledge 70 extending from a parapet 72 surrounding a dance floor 80. The locker 10 or bank 76 is secured underneath the support, i.e. table 64 or ledge 70.

The building 68 comprises a toilet 74 with a bank 76 of said lockers within 2 m of an entrance 78 to the toilet. The building also comprises a defined dance floor 80 with a said locker within 5 m of the dance floor. There is a parapet 72 in the region of a perimeter portion of the dance floor, said parapet being provided with a said locker or a bank (e.g. a single horizontal row of lockers), as described above.

The token 20 is flat and card-like to be adapted for insertion in a slot 24 in such a locker to unlock the same. Each locker is identified by an individual number also on the token.

To keep the lockers 10 cool, cold air may be supplied, e.g. by an internal cooler included in means 46, or, more particularly, e.g. in the case of a bank 76 of the lockers 10, by ducting that passes cold air through the lockers 10, e.g. going from one to another (in series) or from a manifold 63 to a plurality of them (in parallel) or in some combination, perhaps selectively, e.g. with a lever or button as means 50 (in which case means 48 changes between red and green according to whether locker 10 is in use or not), to allow a cold air inlet in means 48 to be opened or closed at will. Equally, if the lockers 10 were used for storing hot drinks 14, to keep the lockers 10 nor drinks 14 warm or hot, heating, or warm or hot air may be supplied, e.g. by an internal heater included in means 46, or such ducting as just described. Likewise, the lockers 10 can be used for storing food, more particularly open food.

In a possible feature, there is a timer, e.g. included in software 54, that causes an indication of when a set time has elapsed after depositing a drink in locker 10, the depositor having been warned of this, e.g. maximum deposit of 1 hr, after which the timer causes the indication. This may be flashing of red light 48, the consequence of which is that the depositor can no longer retrieve the drink, and the flashing will alert a member of staff, e.g. the barman, to use a master key to open the locker 10, retrieve the drink and dispose of it, and re-set the locker for further normal use. This, or any other mis-use of a locker, e.g. to store drugs as mentioned above, may be signalled remotely to staff, e.g. covertly, e.g. electronically by said software.

It will be apparent to one skilled in the art, that features of the different embodiments disclosed herein may be omitted, selected, combined or exchanged and the invention is considered to extend to any new and inventive combination thus formed. Where a preference or particularisation is stated, there is implied the possibility of its negative, i.e. a case in which that preference or particularisation is absent.

Many variations of the invention and embodiments hereinbefore described will be apparent to people skilled in the art and all such variations are to be considered as falling within the scope of the invention.

1-64. (canceled)

65. A security locker adapted to hold an open drink, including a lockable door and a timer that causes an indicator to indicate when a set time has elapsed.

66. The security locker of claim 65 wherein the indicator is a flashing light.

67. The security locker of claim 65 wherein the indicator is adapted to indicate whether the locker is in use or not.

68. The security locker of claim 65 wherein there is at lease one further indicator to indicate whether the locker is in use or not.

69. The security locker of claim 65 wherein the door is locked and/or opened by the insertion of a credit card or key.

70. The security locker of claim 65 wherein the door is adapted to move around an inside or periphery of the locker.

71. The security locker of claim 70 wherein the door rotates around a pivot.

72. The security locker of claim 65 including a removable spill tray or internal floor structure.

73. The security locker of claim 65 wherein the door is clear, slightly translucent or comprises a window portion to facilitate viewing of the contents of the locker.

74. The security locker of claim 65 having an internal storage space for the drink of less than 40 cm high and/or 20 cm wide.

75. The security locker of claim 65 having a securing means to enable a plurality of lockers to be fastened together.

76. The security locker of claim 65 adapted to take payment.

77. The security locker of claim 65 comprising a plurality of the security lockers forming a bank of security lockers.

78. The security locker of claim 77 wherein the bank of security lockers includes securing structure to removably secure the lockers to a support.

79. The security locker of claim 77 wherein the bank of security lockers is in a public house, restaurant or nightclub.

80. The security locker of claim 79 wherein the public house, restaurant or nightclub has a parapet provided with the bank of lockers.

81. The security locker of claim 65 wherein the security locker is in a public house, restaurant or nightclub.

82. The security locker of claim 81 wherein the public house, restaurant or nightclub has a parapet provided with the security locker.
